(19) United States
(12) Patent Application Publication
(10) Pub. No.: US 2017/0244895 A1
(43) Pub. Date: Aug. 24, 2017

(54) SYSTEM AND METHOD FOR AUTOMATIC REMOTE ASSEMBLY OF PARTIALLY OVERLAPPING IMAGES

(71) Applicant: PROJECT RAY LTD., Yokneam (IL)

(72) Inventors: Boaz ZILBERMAN, Ramat Hasharon (IL); Michael VAKULENKO, Zichron Yaakov (IL); Nimrod SANDLERMAN, Ramat-Gan (IL)

(73) Assignee: PROJECT RAY LTD., Yokneam (IL)

(21) Appl. No.: 15/437,876

(22) Filed: Feb. 21, 2017

Related U.S. Application Data
(60) Provisional application No. 62/299,177, filed on Feb. 24, 2016.

(51) Int. Cl. H04N 5/232; H04N 1/00; H04N 5/265; G06T 7/00; G06T 7/33; G06T 3/40

(52) U.S. Cl. CPC H04N 5/23238; G06T 7/337; G06T 3/4092; H04N 5/265; G06T 7/0002; G06T 3/4038; H04N 1/00222; H04N 1/00137; H04N 1/00167; H04N 1/00164; G06T 2207/20221

(57) ABSTRACT

A system for creating a panorama image in real time across a bandwidth-limited network by communicating low-resolution images and selected high-resolution image portions, and registering (stitching) the low-resolution images based on shared objects in the high-resolution image portions.

### FIELD

The method and apparatus disclosed herein are related to the field of communicating imaging, and, more particularly, but not exclusively to systems and methods for automatic assembly of overlapping images, and, more particularly, but not exclusively to a systems and methods for remote assembly of panorama images by selecting resolution of particular image portions.

### BACKGROUND

Creating a panorama image from a plurality of partially overlapping images is known in the art. Creating a panorama requires registering the overlapping areas in sufficient accuracy and compensating for various optical differences between the partially overlapping images. To achieve a result of sufficient quality this process requires images of sufficient resolution, which is mitigated when a panorama image is created ‘on-the-fly’ via a bandwidth-limited network.

Communicating images is also known in the art, including communicating images in real-time. Due to the rich amount of data contained by the imaging, and the limited-bandwidth of the communication media, limitation on the resolution of the communicated content is useful and well known, including various compression methods. It is therefore known and used in the art to obtain image data in relatively high-resolution and communicate image data in reduced, or lower, resolution.

It is also known to control the communicated resolution according to needs, for example, as disclosed in US patent applications 20040120591 and 20080060032. However, due to the increased level of resolution of the cameras in use, the limited-bandwidth of the communication media remains an obstacle for sourcing high-resolution imaging in real-time or near real-time situations.

Therefore, collecting images at one end of the network, communicating reduced resolution images to another end of the network, and then registering these reduced resolution images to create an accurate panorama image remains a problem.

There is thus a widely recognized need for, and it would be highly advantageous to have, a system and method for delivering a panorama image over the network devoid of the above limitations.

### SUMMARY OF THE INVENTION

According to one exemplary embodiment there is provided a method, a device, and/or computer program for registering together two or more images to create a panorama image by performing the steps of: acquiring a plurality of at least partly overlapping high-resolution images by an imaging device in a first location; converting, in the first location, the plurality of least partly overlapping high-resolution images into a respective plurality of least partly overlapping low-resolution images; communicating the plurality of at least partly overlapping low-resolution images, via a communication network, to a panorama creation device in a second location; identifying, in the second location, at least one shared object within an overlapping part of at least two images of the plurality of least partly overlapping low-resolution images; communicating, from the first location to the second location, high-resolution image portions of the at least two images, the image portions including the shared object; and registering the at least two images based on the shared object in the high-resolution image portions.

According to another exemplary embodiment there is provided a method, a device, and a computer program for registering together two or more images to create a panorama image by performing the steps of: acquiring, by a panorama assembly station, via a communication network, from a camera in a remote location, a plurality of low-resolution images; acquiring, by the panorama assembly station, via the communication network, from the camera a plurality of high-resolution image portions of the images; and assembling, in the panorama assembly station, a panorama image including the low-resolution images by registering the low-resolution images using the high-resolution image portions.

According to yet another exemplary embodiment, the high-resolution image portion may have area much smaller than its respective low-resolution image; the high-resolution image portions may include a small part of its respective low-resolution image; the high-resolution image portion may be selected by the panorama assembly station; the high-resolution image portion may be selected by the panorama assembly station from a plurality of high-resolution image portions associated with the low-resolution image; the high-resolution image portions may include objects shared by at least two of the low-resolution source image; the panorama assembly station may determine the high-resolution image portions around objects shared by at least two of the low-resolution source image; and/or the high-resolution image portions may include at least one feature accurately associated with at least one feature of the low-resolution source image.

According to still another exemplary embodiment the method, device, and/or computer program may additionally perform at least one of: recognize, in the panorama assembly station, at least one common object in at least two low-resolution images; define, in the panorama assembly station, for each of the at least two low-resolution images, an image portion including the common object; communicate, from the panorama assembly station to the camera, a request for a high-resolution image data of the image portions; receive, by the panorama assembly station from the camera, the high-resolution image portions; and assemble, in the panorama assembly station, the at least two low-resolution images, according to the common object in the respective high-resolution image portions.

Further according to another exemplary embodiment the low-resolution panorama image may be assembled in real-time remotely from the first location of acquiring the plurality of source images by a camera, and/or the panorama image may include high-resolution registration of the source images.

Yet further according to another exemplary embodiment the camera in the first location and the remote panorama assembly station may be connected by a limited-bandwidth communication network, the limited-bandwidth being insufficient to communicate high-resolution images of the low-resolution images in real-time.

Even further according to another exemplary embodiment the method, device, and/or computer program for registering together two or more images to create a panorama image additionally include identifying a plurality of characteristics of at least one of the images, the image portions, and objects shared by at least two of the low-resolution source images, calculating registration error for the panorama image, identifying a set of the shared objects for which the registration error is at least one of minimal and smaller than a threshold value; and determining characteristics of at least one of the images, the image portions, and shared objects resulting in the registration error being at least one of minimal and smaller than a threshold value. Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified illustration of a panorama system for creating and communicating panorama images;

FIG. 2 is a simplified block diagram of a computing system used by the panorama system;

FIG. 3 is a simplified illustration of a communication channel for communication panorama imaging;

FIG. 4A is a simplified illustrations of a plurality of images taken by a camera of the system for creating and communicating panorama images;

FIG. 4B is a simplified illustrations of a panorama image made from images of FIG. 4A, as may be displayed on a screen of a remote viewing station of the system for creating and communicating panorama images;

FIG. 5 is a simplified illustration of a panorama image;

FIG. 6 is a simplified illustration of a combined image made of a plurality of images having a shared feature;

FIG. 7 is a simplified flow-chart of a panorama creation process; and

FIG. 8 is a simplified flow-chart of a registration process.

### DESCRIPTION OF THE PREFERRED EMBODIMENTS

The present embodiments comprise systems and methods for creating and communicating a panorama image. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of the embodiments is to provide at least one system and/or method enabling a first user to create a plurality of partially overlapping images, and a second user to scroll through the plurality of partially overlapping images presented as a panorama image.

In this context, the term ‘panorama’ or ‘panorama image’ refers to an assembly of a plurality, or collection, or sequence, of images (source images) arranged to form an image larger than any of the source images making the panorama. The term ‘particular image’ or ‘source image’ may refer to any single image of the plurality, or collection, or sequence of images from which the panorama image is made of.

The term ‘image’ in this context refers to any type or technology for creating an imagery data, such as photography, still photography, video photography, stereo-photography, three-dimensional (3D) imaging, thermal or infra-red (IR) imaging, etc. In this context any such image may be ‘captured’, or ‘obtained’ or ‘photographed’.

The term panorama image may therefore include a panorama image assembled from images of the same type and/or technology, as well as a panorama image assembled from images of the different types and/or technologies.

The term ‘register’, ‘registration’, or ‘registering’ refers to the action of locating particular features within the overlapping parts of two or more images, correlating the features, and arranging the images so that the same features of different images fit one over the other to create a consistent and/or continuous image, namely, the panorama.

The term ‘camera’ in this context refers to a device of any type or technology for creating one or more images or imagery data such as described herein, including any combination of imaging type or technology, etc.

The term ‘local camera’ refers to a camera obtaining images (or imaging data) in a first place and the terms ‘remote user’ and ‘remote system’ or ‘remote station’ refer to a user and/or a system or station for viewing or analyzing the images obtained by the local camera in a second location, where the second location is remote from the first location. The term ‘location’ may refer to a geographical place or a logical location within a communication network.

The term ‘remote’ in this context may refer to the local camera and the remote station being connected by a limited-bandwidth network. For this matter the local camera and the remote station may be connected by a limited-bandwidth short-range network such as Bluetooth. The term limited-bandwidth' may refer to any network, or communication technology, or situation, where the available bandwidth is insufficient for communicating the high-resolution images, as obtained, in their entirety, and in real-time or sufficiently fast. In other words, limited-bandwidth' may mean that the resolution of the images obtained by the local camera should be reduced before they are communicated to the viewing station in order to achieve low-latency.

The term ‘resolution’ herein may refer to any aspect of the amount of information associated to any type of image. Such aspects may be, for example:

Spatial resolution, or granularity, represented, for example, as pixel density or the number of pixels per area unit (e.g., pixels per square inch or square centimeter).

Temporal resolution, represented, for example, the number of images per second, or as frame-rate.

Color resolution or color depth, or gray level, or intensity, or contrast, represented, for example, as the number of bits per pixel.

Compression level or type, including, for example, the amount of data loss due to compression. Data loss may represent any of the resolution types described herein, such as spatial, temporal and color resolution.

Any combination thereof The term ‘server’ or ‘communication server’ refers to any type of computing machine connected to a communication network to enabling communication between one or more cameras (e.g., a local camera) and one or more remote users and/or remote systems.

The term ‘network’ or ‘communication network’ refers to any type of communication medium, including but not limited to, a fixed (wire, cable) network, a wireless network, and/or a satellite network, a wide area network (WAN) fixed or wireless, including various types of cellular networks, a local area network (LAN) fixed or wireless, and a personal area network (PAN) fixes or wireless, and any combination thereof.

The term ‘panning’ or ‘scrolling’ refers to the ability of a user to select and/or view a particular part of the panorama image. The action of ‘panning’ or ‘scrolling’ is therefore independent of the form-factor, or field-of-view of any particular image from which the panorama image is made of. A user can therefore select and/or view a particular part of the panorama image made of two or more particular images, or parts of two or more particular images.

In this respect, a panorama image may use a sequence of video frames to create a panorama picture and a user may then pan or scroll within the panorama image as a large still picture, irrespective of the time sequence in which the video frames were taken.

The purpose of the panorama creation process described herein is to provide a remote user with a stable panorama image, where the panorama image is combined by registering individual images (e.g., still pictures and/or video frames, and/or any other imaging technology) as they are received from a local camera operated by a local user. As the panorama is created in real-time, or near real-time, or ‘on-the-fly’ the quality of the pictures (e.g., the resolution) should be adapted to the available bandwidth of the network. Therefore, the panorama creation process receives low quality, or low-resolution images.

The panorama creation process is therefore adapted to use low-resolution images. However, registering (stitching together) images of low resolution is inaccurate, generating a registration error that accumulates with the number of images combined to make the panorama image. The purpose of the panorama creation process is to produce an accurately registered panorama image from low-resolution images as communicated in real-time from the local camera.

It is appreciated that the network bandwidth may change with time, and therefore the received image resolution may change with time, and the panorama creation process has to adapt to the various levels of resolution of the communicated images. The purpose is therefore to create an accurately registered panorama image, remotely from the camera, in real-time, via a limited-bandwidth communication network, requiring the communication of low-resolution images.

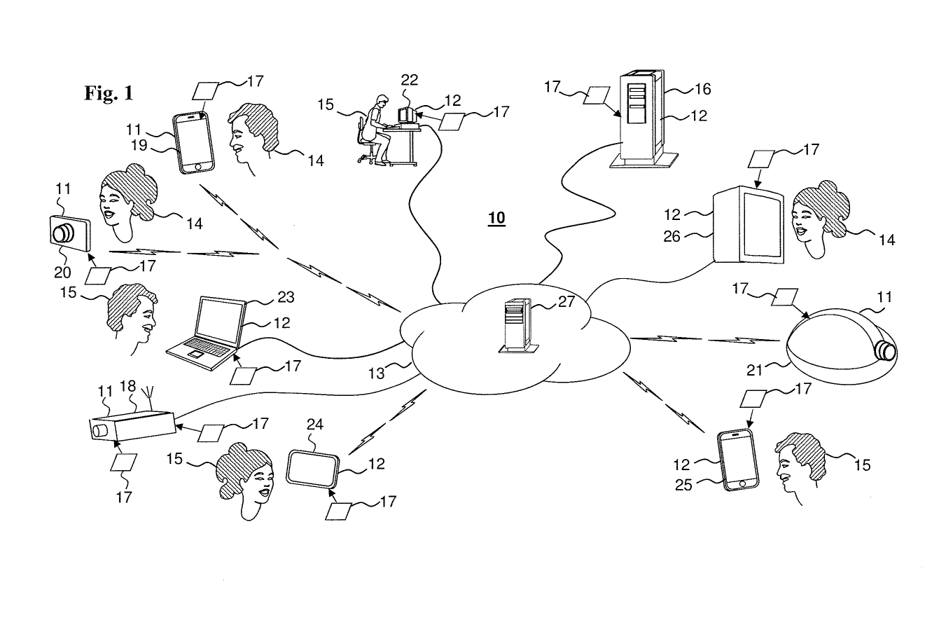

Reference is now made to FIG. 1, which is a simplified illustration of a panorama system 10, for creating and communicating panorama images, according to one exemplary embodiment.

As shown in FIG. 1, panorama system 10 may include at least one local camera 11 in a first location, and at least one remote viewing station 12 in a second location. A communication network 13 connects between local camera 11 and the remote viewing station 12. Camera 11 may be operated by a first, local, user 14, while remote viewing station 12 may be operated by a second, remote, user 15. Alternatively or additionally, remote viewing station 12 may be operated by, or implemented as, a computing machine 16 such as a server, which may be named herein imaging server 16. These remote viewing station 12 and/or imaging server 16 may be termed herein ‘panorama creation device’ or ‘panorama assembly station’.

Local camera 11 may include panorama processing software 17 or a part of panorama processing software 17, remote viewing station 12 may include panorama processing software 17 or a part of panorama processing software 17, and/or imaging server 16 may include panorama processing software 17 or a part of panorama processing software 17.

Camera 11 may include an imaging device capable of providing still pictures, video streams, three-dimensional (3D) imaging, infra-red imaging (or thermal radiation imaging), stereoscopic imaging, etc. and combinations thereof. Camera 11 may be a fix video camera (18) or can be part of a mobile computing device such as a smartphone (19). Camera 11 may be hand operated (20) or head mounted (or helmet mounted 21), or otherwise wearable. Camera 11 may be mounted on any type of mobile device or vehicle, including any type of flying machine, etc. Each camera 11 may include a remote-resolution local-imaging module.

Remote viewing station 12 may be any computing device such as a desktop computer 22, a laptop computer 23, a tablet or PDA 24, a smartphone 25, a monitor 26 (such as a television set), etc. Remote viewing station 12 may include a (screen) display for use by a remote second user 15. Each remote viewing station 12 may include a remote-resolution remote-imaging module.

Communication network 13 may be any type of network, and/or any number of networks, and/or any combination of networks and/or network types, etc.

A distribution server 27 may be part of the communication network 13 (as shown in FIG. 13), or externally connected to communication network 13.

Panorama system 10 is configured to present to a remote user such as user 15 of a remote viewing station 12, a stable and accurate panorama image in real-time, while the flow of imaging data continues. Particularly, panorama system 10 may provide an accurately registered panorama of low-resolution images, in real-time via a limited-bandwidth network, by using selected high-resolution image portions.

It is appreciated that one of the features of panorama system 10 is the ability to perform the following steps:

Capture a plurality of high-resolution images in a first side of a limited bandwidth network (e.g., by one or more cameras 11).

Convert the high-resolution images into relatively low-resolution images in the first side of the limited bandwidth network.

Communicate the low-resolution images via the limited bandwidth network to a second side of the limited bandwidth network.

Create an accurately-registered panorama image in the second side of the limited bandwidth network, from the low-resolution images.

It is appreciated that one of the features of panorama system 10 may accurately register the images received in the second side, overcoming their low-resolution.

It is appreciated that accurately-registered panorama images may be based on high resolution image portions communicated from a camera 11 to a remote viewing station 12, and/or imaging server 16, responsive to a particular request from the receiving end.

It is appreciated that panorama system 10 may include any number of cameras 11, and/or remote viewing stations 12, and/or imaging servers 16. It is appreciated that any number of cameras 11 may communicate with any remote viewing stations 12, and/or imaging servers 16. It is appreciated that any number of remote viewing stations 12, and/or imaging servers 16 may communicate with any camera 11.

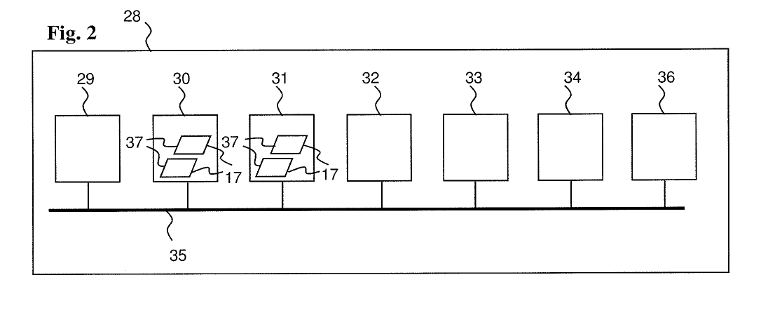

Reference is now made to FIG. 2, which is a simplified block diagram of a computing system 28, according to one exemplary embodiment. As an option, the block diagram of FIG. 2 may be viewed in the context of the details of the previous Figures. Of course, however, the block diagram of FIG. 2 may be viewed in the context of any desired environment. Further, the aforementioned definitions may equally apply to the description below.

Computing system 28 is a block diagram of a generic example of a computing system, or device, 28, used for implementing a camera 11 (or a computing device hosting camera 11), and/or a remote viewing station 12 (or a computing device hosting remote viewing station 12), and/or an imaging server 16 (or a computing device hosting imaging server 16). The term ‘computing system’ or ‘computing device’ relates to any type or combination of computing devices, or computing-related units, including, but not limited to, a processing device, a memory device, a storage device, and/or a communication device.

As shown in FIG. 2, computing system 28 may include at least one processor unit 29, one or more memory units 30 (e.g., random access memory (RAM), a non-volatile memory such as a Flash memory, etc.), one or more storage units 31 (e.g. including a hard disk drive and/or a removable storage drive, representing a floppy disk drive, a magnetic tape drive, a compact disk drive, a flash memory device, etc.). Computing system 28 may also include one or more communication units 32, one or more graphic processors 33 and displays 34, and one or more communication buses 35 connecting the above units.

It is appreciated that a communication unit 32 may enable computing system 28 to communicate with one or more other computing systems 28 over one or more communication networks.

In the form of camera 11, computing system 28 may also include an imaging sensor 36 configured to create a still picture, a sequence of still pictures, a video clip or stream, a 3D image, a thermal (e.g., IR) image, stereo-photography, and/or any other type of imaging data and combinations thereof.

Computing system 28 may also include one or more computer programs 37, or computer control logic algorithms, which may be stored in any of the memory units 30 and/or storage units 31. Such computer programs, when executed, enable computing system 28 to perform various functions (e.g. as set forth in the context of FIG. 1, etc.). Memory units 30 and/or storage units 31 and/or any other storage are possible examples of tangible computer-readable media. Particularly, computer programs 37 may include panorama processing software 17 or a part of panorama processing software 17.

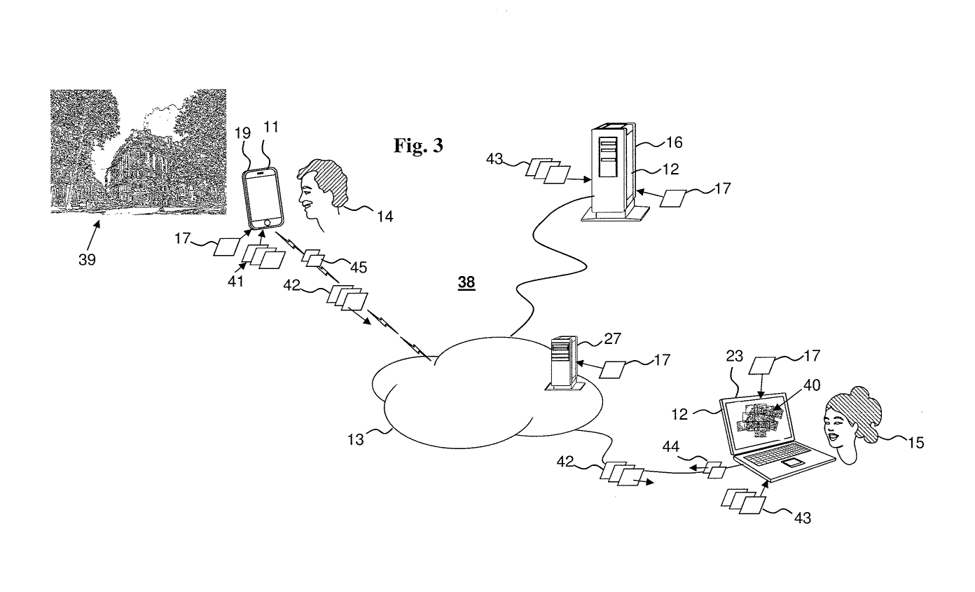

Reference is now made to FIG. 3, which is a simplified illustration of a communication channel 38 for communication panorama imaging, according to one exemplary embodiment. As an option, the illustration of FIG. 3 may be viewed in the context of the details of the previous Figures. Of course, however, the illustration of FIG. 3 may be viewed in the context of any desired environment. Further, the aforementioned definitions may equally apply to the description below.

As shown in FIG. 3, communication channel 38 may include a camera 11 typically operated by a first, local, user 14 and a remote viewing station 12, typically operated by a second, remote, user 15. Camera 11 and remote viewing station 12 typically communicate over communication network 13. Communication channel 38 may also include imaging server 16 and/or distribution server 27. Camera 11, and/or remote viewing station 12, and/or imaging server 16 may include computer programs 37, which may include panorama processing software 17 or a part of panorama processing software 17.

As shown in FIG. 3, user 14 may be located in a first place photographing surroundings 39, which may be outdoors, as shown in FIG. 3, or indoors. User 15 may be located remotely, in a second place, watching a panorama image 40 created from images taken by camera 11 operated by user 14.

As an example user 14 may be a visually impaired person out in the street, in a mall, or in an office building and have orientation problems. User 14 may call for assistance of a particular user 15, who may be a relative, or may call a help desk which may assign an attendant of a plurality of attendants currently available. As shown and described with reference to FIG. 1, user 15 may be using a desktop computer with a large display, or a laptop computer, or a tablet, or a smartphone, etc.

As another example of the situation shown and described with reference to FIG. 3, user 14 may be a tourist traveling in a foreign country and being unable to read signs and orient himself appropriately. As another example, user 14 may be a first responder or a member of an emergency force. For example, user 14 may stick his hand with camera 11 into a space and scan it so that another member of the group may view the scanned imagery. For this matter, users 14 and 15 may be co-located.

A session between a first, local, user 14 and a second, remote, user 15 may start by the first user 14 calling the second user 15 requesting help, for example, navigating or orienting (finding the appropriate direction). In the session, the first user 14 operates the camera 11 and the second user 15 views the images provided by the camera and directs the first user 14.

A typical reason for the first user to request the assistance of the second user is a difficulty seeing, and particularly a difficulty seeing the image taken by the camera. Such reason is that the first user is visually impaired, or being temporarily unable to see. The camera display may be broken or stained. The first user's glasses, or a helmet protective glass, may be broken or stained. The user may hold the camera with the camera display turned away or with the line of sight blocked (e.g., around a corner). Therefore, the first user does not see the image taken by the camera, and furthermore, the first user does not know where exactly the camera is directed. Therefore, the images taken by the camera 11 operated by the first user 14 are quite random.

The first user 14 may call the second user 15 directly, for example by providing camera 11 with a network identification of the second user 15 or the remote viewing station 12. Alternatively, the first user 14 may request help and the distribution server 27 may select and connect the second user 15 (or the remote viewing station 12). Alternatively, the second user 15, or the distribution server 27 may determine that the first user 14 needs help and initiate the session. Unless specified explicitly, a reference to a second user 15 or a remote viewing station 12 refers to an imaging server 16 too.

Typically, first user 14 operating camera 11, may capture a plurality of images 41, such as a sequence of still pictures or a stream of video frames. Alternatively, or additionally, first 14 may operate two or more imaging devices, which may be embedded within a single camera 11, or implemented as two or more devices, all referenced herein as camera 11. Alternatively, or additionally, a plurality of first users 14 operating a plurality of cameras 11 may take a plurality of images. Images 41 are typically of high-resolution and may be stored in camera 11 or in a mobile computation device associated with camera 11.

Camera 11 may then convert a plurality of images into low-resolution images 42, and transmit low-resolution images 42 to viewing station 12 (and/or imaging server 16), typically by using panorama processing software 17 or a part of panorama processing software 17 embedded in cameras 11.

The plurality of imaging devices herein may include imaging devices of different types, or technology, producing images of different types, or technologies, as disclosed above (e.g., still, photography, video, stereo-photography, 3D imaging, thermal imaging, etc.).

Alternatively, or additionally, the plurality of images is transmitted by cameras 11 to an imaging server 16 that may then transmit images to viewing station 12 (or rather, viewing station 12 may retrieve images from imaging server 16).

Viewing station 12 and/or imaging server 16, may then create a one or more panorama images 43 from any subset plurality of images of the plurality of images 42. Viewing station 12 may retrieve panorama images 43 from imaging server 16.

To accurately register images 42 into panorama image 43 viewing station 12 (and/or imaging server 16) may send to the respective camera 11 a request for a particular high-resolution image portion, for example in the form of a portion identifier 44. Camera 11 may then transmit to the viewing station 12 (and/or imaging server 16) the required high-resolution image portion 45.

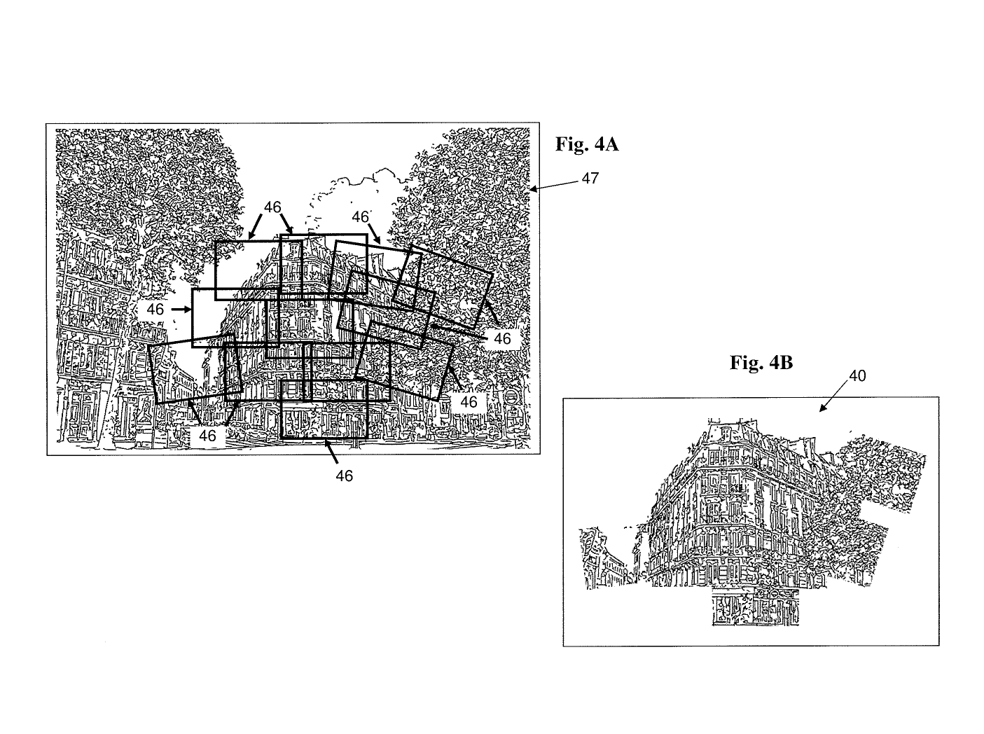

Reference is now made to FIG. 4A and FIG. 4B, which are simplified illustrations of a plurality of images 46 of an object, or view, 47, according to one exemplary embodiment.

As an option, the illustrations of FIGS. 4A and 4B may be viewed in the context of the details of the previous Figures. Of course, however, the illustration of FIGS. 4A and 4B may be viewed in the context of any desired environment. Further, the aforementioned definitions may equally apply to the description below.

FIG. 4A shows object 47 and a plurality of images 46 taken by a camera such as camera 11 of FIGS. 1 and 3. Images 46 may correspond to images 41 of FIG. 3.

As shown in FIG. 4A, images 46 are at least partly overlapping. Images 46 may have been taken by a camera 11, or a plurality of cameras 11, possibly sweeping across object 47, creating a sequence of images 46. Images 46 may therefore be a sequence of still images, a sequence, or stream, of video frames, one or more stereo-pictures, 3D images, thermal images, etc., or combinations thereof. Images 46 may have been taken by rotating camera 11 or moving camera 11 or both. Therefore the orientation, or angle of the camera with respect to object 47 as well as the field of view of camera 11 and/or its distance from object 47 may change with every image.

FIG. 4B shows a panorama image made from images 46 as may be displayed on a screen of a remote viewing station such as remote viewing station 12 of FIGS. 1 and 3.

Returning to the communication channel 38 of FIG. 3, it is appreciated that in a first phase of communication, camera 11 sends (or transmits) to viewing station 12 and/or imaging server 16 the plurality of images 46 in relatively low-resolution. Camera 11 may use panorama processing software 17 (or a part of panorama processing software 17) to send images 46 to viewing station 12 and/or imaging server 16.

One reason, for example, for sending images in low-resolution is a limitation on a communication parameter such as bandwidth (e.g., bits per second). Sending images 46 from camera 11 to be viewed in real-time, or near-real-time, by a user at viewing station 12 using network 13 having a limited-bandwidth requires sending low-resolution version of images 46.

Therefore, while images 46 may be taken by camera 11 in relatively high-resolution (and stored therewith in high-resolution), camera 11 may convert the high-resolution images 46 into low-resolution images 46 and send the low-resolution images 46 to viewing station 12 and/or imaging server 16.

Converting an image from a high-resolution version or format into a low-resolution version or format may be executed in any manner know in the art such as by reducing the number of bits per pixel, reducing pixel density (e.g., the number of pixels per area), using a lossy compression, etc.

Thereafter, viewing station 12 and/or imaging server 16 combine at least two of the low-resolution images 46 into a panorama image.

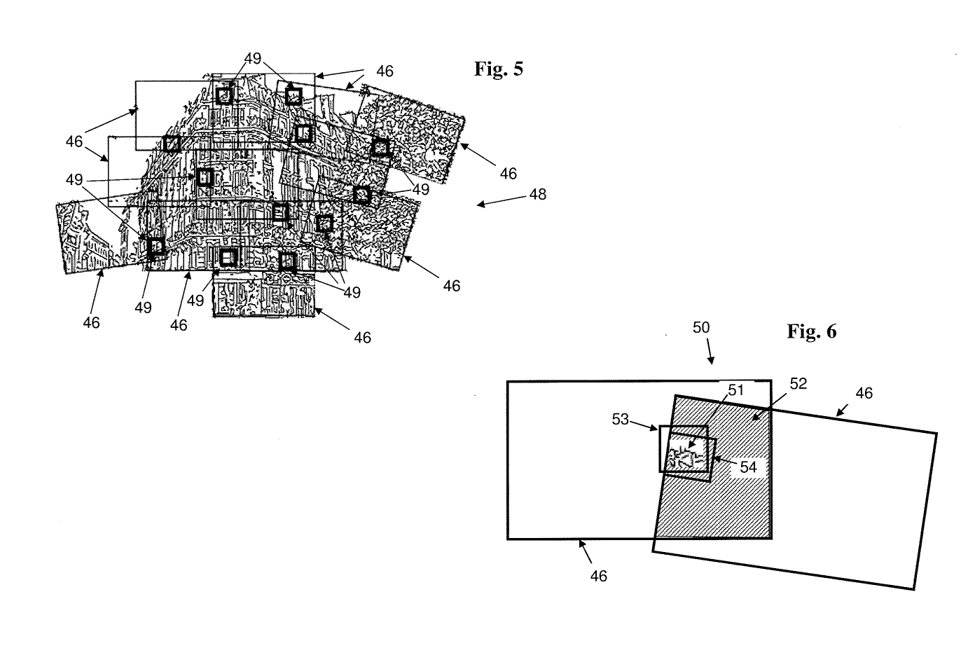

Reference is now made to FIG. 5, which is a simplified illustration of a panorama image 48, according to one exemplary embodiment.

As an option, panorama image 48 of FIG. 5 may be viewed in the context of the details of the previous Figures. Of course, however, the FIG. 5 may be viewed in the context of any desired environment. Further, the aforementioned definitions may equally apply to the description below.

As shown in FIG. 5, panorama image 48 includes a plurality of images 46 sent by camera 11 to viewing station 12 and/or imaging server 16, typically in the form of low-resolution images 46. Panorama image 48 may be created by viewing station 12 and/or imaging server 16 registering the low-resolution images 46 according to features or artifacts in their respectively overlapping areas. To register any two or more low-resolution images 46 sharing an overlapping area (or a feature or artifact therewith), viewing station 12 and/or imaging server 16 may use panorama processing software 17 (or a part of panorama processing software 17) to create panorama image 48.

For example, when registering two or more low-resolution images 46 according to features or artifacts in their respectively overlapping areas viewing station 12 and/or imaging server 16 may request camera 11 to send a high-resolution image of the particular features or artifacts or overlapping area share between the images 46 being registered.

As shown in FIG. 5, each image 46 includes one or more overlapping areas and within such overlapping area one or more artifacts. The term ‘artifact’ may refer to any part or component of the photographed object (such as object 47 of FIG. 4A) that may serve to accurately register two or more images or an image of such part or component contained in two or more images 46. Image portions containing such artifacts are designated in FIG. 5 by numeral 49. It is appreciated that such image portion 49 is much smaller than its respective image 46, and thus the overall area of the image portions 49 of a panorama 47 is much smaller than the total area of the panorama 47.

Reference is now made to FIG. 6, which is a simplified illustration of a combined image 50 made of a plurality of images 46 including a shared feature 51, according to one exemplary embodiment.

As an option, the illustration of FIG. 6 may be viewed in the context of the details of the previous Figures. Of course, however, FIG. 6 may be viewed in the context of any desired environment. Further, the aforementioned definitions may equally apply to the description below.

It is appreciated that combined image 50 may represent a panorama image, or a part of panorama image, such as panorama image 40 of FIGS. 3 and 4B.

As shown in FIG. 6, combined image 50 includes two images 46, however, combined image 50 may include any number of images 46. Images 46 of combined image 50 have a shared or overlapping area 52. Overlapping area includes shared feature (or artifact, or object) 51 such as included or appearing in image portions 49 of panorama 47 of FIG. 5.

It is appreciated that the two (or more) images 46 have been received by a viewing station (and/or by an imaging server) such as remote viewing station 12 (and/or imaging server 16) of FIGS. 1 and 3. Typically, images 46 have been received by a viewing station (and/or imaging server) in the form of low-resolution images. Viewing station (and/or by imaging server) may now assemble, or combine images 46 to create a combined image 50, or a panorama image.

To accurately register (e.g., combine, assemble) the two images 46 of combined image 50, the panorama processing software 17 (or part thereof in the viewing station 12 and/or imaging server 16) requests camera 11 (that is, the panorama processing software 17, or part thereof, in the camera 11) to send high-resolution (or higher-resolution) versions of respective image portions 53 and 54. As shown in FIG. 6, image portions 53 and 54 at least partially contain at least a part of shared or overlapping area 52 and/or the area designated as the image portion 49 in FIG. 5.

Image portions such as image portions 53 and 54 of FIG. 6 are accurately located in their respective high-resolution images 46. This term ‘accurately located’ may mean that at least one feature of the image portion is associated with at least one feature of the respective image 46 in terms of high-resolution. A feature of the image portion and/or the image 46 may be, for example, the center of the image, or the upper-left corner of the image, etc. Two or more such features may be used, such as two opposing corners.

Accurately locating, or associating, in terms of high resolution may mean, for example, that the X, Y values of the feature of the image portion with respect to the feature of the images 46 are given as high-resolution pixel count. For example, the higher-left corner of the image portion is located N1 high-resolution pixels in the X dimension, and N2 high-resolution pixels in the Y dimension, from the higher-left corner of the respective images 46. This data accurately associating the location of an image portion with its respective image 46 is termed herein ‘portion location data’.

Panorama system 10 enables a local camera 11 to obtain, or capture, images in high-resolution and communicate these images via a limited-bandwidth network to a remote viewing station (or imaging server) as low-resolution images. The remote viewing station (or imaging server) may then combine two or more of these low-resolution images, in real-time, to create a panorama image. The remote viewing station (or imaging server) may register the low-resolution images accurately by requesting selected high-resolution image portions from camera 11. Each such high-resolution image portion (53 and 54 in FIG. 6) is accurately localized within its respective low-resolution image 46. As the image portions are of high-resolution the remote viewing station (or imaging server) may accurately register (orient) the low-resolution image 46 to form the combined image 50, and/or a panorama image 40.

Hence panorama system 10 may create an accurate image 50, and/or a panorama image 40 from low-resolution image 46. It is appreciated that image portion 53 may be a relatively small part of a respective first image 46. Therefore panorama system 10 may communicate an accurately registered panorama image via a limited-bandwidth network by communicating a majority of the images 46 in low-resolution and only a small, selected, part of images 46 (namely, image portions such as image portions 53 and 54 of FIG. 6) in high-resolution.

More information regarding possible processes and/or embodiments for requesting and/or receiving high-resolution (or higher-resolution) versions of image portions may be found in U.S. Provisional Patent Application No. 62/276871, titled “Remotely Controlled Communicated Image Resolution”, filed Jan. 10, 2016, which is incorporated herein by reference in their entirety.

In one embodiment, camera 11 divides one or more of images 46 into a plurality of image portions and the panorama assembly station (remote viewing station 12 and/or imaging server 16) may then select the image portion containing the desired artifact. In such situation camera 11 may send to the panorama assembly station a portion identifier for each of the image portions. The panorama assembly station may then determine the required image portion and sends to camera 11 the portion identifier associated with the required image portion. Camera 11 may then send to the panorama assembly station a high-resolution version of the image portion, along with the portion location data (in respective high-resolution units).

In another embodiment the panorama assembly station determines the location of the required artifact and sends to camera 11 a portion identifier defining the location of the artifact and the required area around it, thus defining an image portion. This portion identifier may include, for example, coordinates of a center point of the artifact and area around it, or coordinates of two opposing corners of a rectangle circumferencing the artifact, etc. The panorama assembly station may send to camera 11 the portion identifier data in terms (e.g., units) of low-resolution. Camera 11 then sends to the panorama assembly station a high-resolution version of the image portion, along with the portion location data in respective high-resolution units.

It is appreciated that the process of creating a panorama image from a plurality of partially overlapping images (still pictures and/or video frames) includes a sequence of action where each action involves two partially overlapping images. Therefore, for example, a second image is registered to a first image, and then a third image is registered to the second image, and so on. Each such registration includes a registration error as the added image is not placed (registered) correctly or accurately to the previous picture.

This registration error accumulates with every registration. At least some of the images are overlapping with more than one another image. Therefore, from time to time, the sequence of registering a new image (N+1) to a previous image (N) has to register to at least one another image (N−M) registered M images previously. In such case the error cumulated over the previous M registrations becomes prohibitive, so that it is impossible to accurately register the new image (N+1) to both the two previous images (e.g., image N and image N−M, or more). That is, the registration error (inaccuracy) between image N+1 and image N, or between image N+1 and image N−M, is too large to be considered accurate registration.

The purpose of the panorama creation process described herein is to minimize the cumulative error to enable accurate registration of as many images as possible. This may be achieved by performing individual registrations according to high-resolution data as provided by the high resolution image portions requested by the remote viewing station from the local camera, and evaluating the cumulative error in low resolution as provided by the low-resolution Images as communicated from the local camera to the remote viewing station.

Therefore, the remote viewing station can receive from the local camera, via a limited-bandwidth network, a stream of images in real-time, and combine these images into a panorama image in real-time, where the images are communicated in low resolution subject to the limited-bandwidth network, however the images are registered to form an accurately registered panorama using high-resolution registration, based on high-resolution image portions.

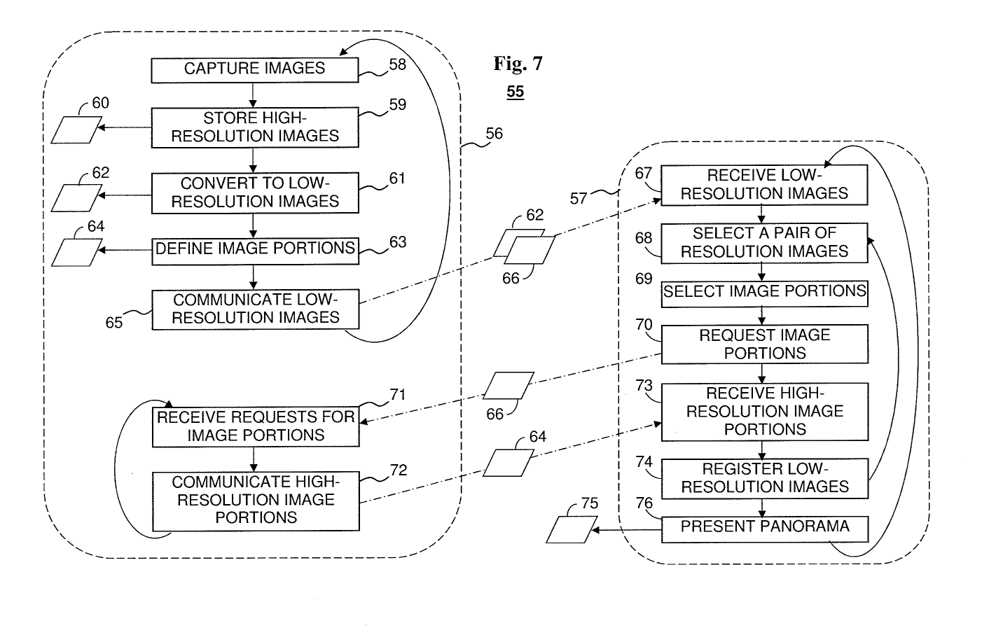

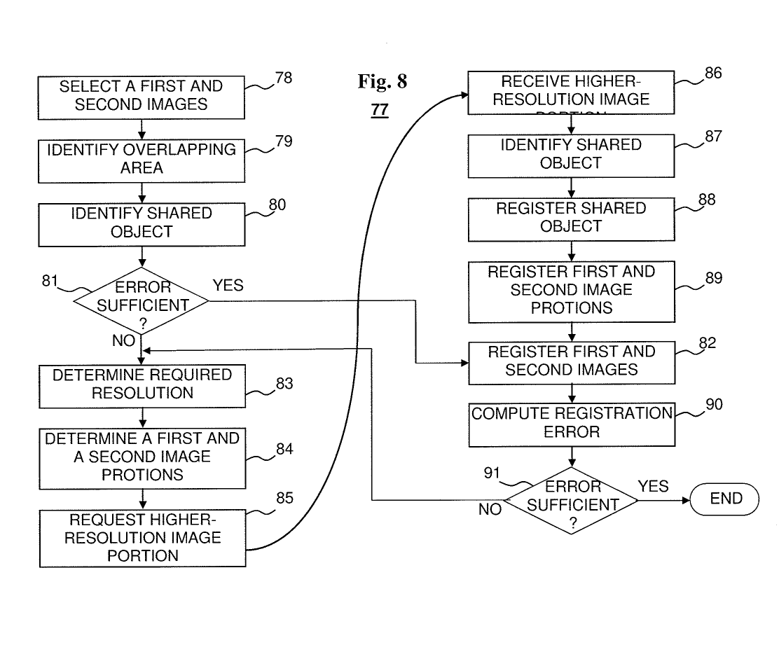

Reference is now made to FIG. 7, which is a simplified flow-chart of a panorama creation process 55, according to one exemplary embodiment.

As an option, the flow-chart of FIG. 7 may be viewed in the context of the details of the previous Figures. Of course, however, FIG. 7 may be viewed in the context of any desired environment. Further, the aforementioned definitions may equally apply to the description below.

Panorama creation process 55 may be executed by a computing machine such as computing system, or device, 28 of FIG. 2. For example, Panorama creation process 55 may implemented as a software such as computer program 37 of FIG. 2, and be executed by a processor such as processor 29 of FIG. 2. Particularly, Panorama creation process 55 may be part of panorama processing software 17.

As shown in FIG. 7, panorama creation process 55 may include two modules. Module 56 may be executed by camera 11, and module 57 may be executed by remote viewing station 12 and/or imaging server 16, as shown and described with reference to FIGS. 1 and/or 3.

Module 56 may start with step 58 by capturing images using any imaging technology as discussed above. Module 56 may proceed to step 59 to store the images 60. The images are captured and stored in high-resolution format. Module 56 may then proceed to step 61 to convert the high-resolution images onto low-resolution images 62.

Module 56 may then proceed to step 63 to define image portions 64. It is appreciated that this step may be optional and that image portions 64 may be defined by module 57. Defining image portions may take the form of portion identifiers as described above. It is appreciated that a portion identifier may include accurate location of such image portion within its respective image as discussed above.

Module 56 may then proceed to step 65 to communicate the low-resolution images 62 and (optionally) their respective definitions of image portions (e.g., portion identifiers 66).

Panorama creation process 55 may then proceed with step 67 of module 57 by receiving the low-resolution images 62 and (optionally) their respective definitions of image portions (e.g., portion identifiers 66).

Module 57 may then proceed with step 68 to select two or more low-resolution images which are at least partly overlapping, or sharing and artifact within a respective image portion. Module 57 may then proceed with step 69 to select an image portion within each of these selected low-resolution images, where the image portion contains the shared artifact.

The term ‘select’ in steps 68 and 69 may apply to a user-interface enabling a user to perform any of the selections of steps 68 and 69, such as remote user 15 of remote viewing station 12. Alternatively or additionally, the term ‘select’ in steps 68 and 69 may apply to an automatic process, typically used by imaging server 16, and/or by remote viewing station 12.

It is appreciated that optionally module 57 define the image portion, for example, by defining the location of the image portion (e.g., a center point or any other feature of the image portion) with respect to the low-resolution image, and the area of the image portion with respect to its location.

Module 57 may then proceed with step 70 to request the image portion by, for example, sending the portion identifier 66 to module 56. Portion identifier 66 may include the location and size of the requested image portion.

Panorama creation process 55 may then proceed with step 71 of module 56 by receiving the image portion request and by communicating (step 72) the high-resolution image portion 64 to module 57.

Panorama creation process 55 may then proceed with step 73 of module 57 by receiving image portions 64 for the shared artifact, and by registering (step 74) the two or more low-resolution images using the high-resolution image portions and their respective high-resolution portion location data.

It is appreciated that steps 68 to 74 (including steps 71 and 72) may repeat for any plurality of low-resolution images to create a panorama image of the selected low-resolution images. The panorama image 75 is then presented (step 76) to the user of the remote viewing station 12.

It is appreciated that panorama image 75 may be displayed while it is assembled by panorama creation process 55. It is appreciated that steps 67 to 76 (including steps 71 and 72) may repeat as long as module 57 receives low-resolution images from module 56. It is appreciated that steps 58 to 76 may repeat so that panorama creation process 55 creates panorama image 75 while it is capturing additional high-resolution images. In this method an accurately registered low-resolution panorama image 75 is created, in real-time via a limited-bandwidth network. It is appreciated that where camera 11, e.g., step 58, captures more images the panorama image 75 may widen (increase its area) or present more details (if, for example, the camera returns to a previously photographed object).

Reference is now made to FIG. 8, which is a simplified flow-chart of a registration process 77, according to one exemplary embodiment.

As an option, the flow-chart of FIG. 8 may be viewed in the context of the details of the previous Figures. Of course, however, FIG. 8 may be viewed in the context of any desired environment. Further, the aforementioned definitions may equally apply to the description below.

Registration process 77 may be executed by a computing machine such as computing system, or device, 28 of FIG. 2. For example, registration process 77 may implemented as a software such as computer program 37 of FIG. 2, and be executed by a processor such as processor 29 of FIG. 2. Particularly, registration process 77 may be part of panorama processing software 17. Particularly, registration process 77 may be executed by a remote viewing station 12 and/or imaging server 16 of FIGS. 1 and/or 3.

Registration process 77 may be understood as a more detailed description of module 57 described with reference to FIG. 7.

As shown in FIG. 8, registration process 77 may start with step 78 by selecting a first image 46 and a second image 46 having a shared or overlapping area 52. Registration process 77 may then proceed to step 79 to identify or determine an overlapping area of the first and second images 46 such as area 52 of FIG. 6. Registration process 77 may then proceed to step 80 to identify or determine a shared object within the overlapping area to be used for registering the two images, such as object 51 of FIG. 6. Registration process 77 may then proceed to step 81 to determine if the resolution of the images of the shared object in the two low-resolution images is sufficient to enable accurate registration.

A measure of the quality of combined image 50 is the registration error, or cumulative registration error for a plurality or sequence of image registrations. Registration error may be measured, for example, as the number of accurately matching pixels between the two (or more) registered images 46, or the number of inaccurately matching pixels between the two (or more) registered images 46. The term ‘accurate’ or inaccurate' may refer to a distance between matching pixels being below or above (respectively) a predefined value. Alternatively, for example, the registration error can be calculated according to the arithmetic mean of the squares of the distances between representative features of the shared objects in such two (or more) registered images 46.

If the registration error is sufficient (e.g., low enough) registration process 77 may then proceed to step 82 to register the two (or more) low-resolution images. If the registration error is insufficient (e.g., to high) registration process 77 may then proceed to step 83 to determine the resolution required to achieve the required registration error.

If the resolution of the current images 46 is not enough (e.g., too low) to enable accurate registration of the images 46 to form a good quality combined image 50 registration process 77 may then proceed to step 84 to determine image portions including the shared object 51, such as image portions 53 and 54 of FIG. 6.

Registration process 77 may then proceed to steps 85 and 86 to request camera 11 to send higher-resolution versions of image portions 53 and 54 and to receive them.

Registration process 77 may then proceed to step 87 to identify the shared object in the image portions, to step 88 to register the high-resolution images of the shared object in the two image portions, to step 89 to register the two high-resolution image portions, and then to step 82 to register the images of two low resolution images.

Registration process 77 may then proceed to step 90 to calculate the registration error, and if the registration error is insufficient (step 91), return to step 83 to determine the required higher resolution of the shared object. To determine if a registration error is sufficient (or not) the measured error may be compared, for example, with a predefined threshold.

One method for reducing the registration error involves requesting the same shared object, and/or image portion, in a higher-resolution, if such higher-resolution is available. An alternative, or additional, method for reducing the registration error involves requesting a second (or more) image portion containing a second (or more) shared object.

It is appreciated that the process described herein, and particularly with respect to steps 83 to 90, can be repeated with increased resolution (e.g., recursively) to reach a desired quality (or accuracy) of the panorama image.

Therefore, using registration process 77, panorama system 10 may provide a remote user or system with an accurately registered panorama image based on a plurality of low-resolution images. This panorama image may be provided in real-time via a limited-bandwidth network based on selected high-resolution image portions of the registered low-resolution images.

As described above, the process of determining the image portions may be manual and/or automatic and/or both. For example, typically (but not exclusively) step 63, and step 69 (of FIG. 7) when executed by imaging server 16, are automatic processes. Step 69 when executed by remote viewing station 12 may be automatic, or involve a manual selection by remote user 15 of remote viewing station 12, or both.

Remote viewing station 12 may use artificial intelligence (AI) software, and/or machine learning (ML) software, and/or a similar technology, to analyze the preferences of remote users 15 of remote viewing stations 12 when selecting an image portion, for example in step 69. Thus, the AI/ML software may develop a methodology, and/or an automatic process, for determining shared objects, and/or image portions and/or forming portion identifiers 66.

For example, the AI/ML program software may classify images (e.g., source images) by their type, such as countryside landscape, urban landscape, street, garden, commercial space, office space, domestic outdoors, domestic indoors, etc. For example, the AWL program software may also classify objects (e.g., shared objects) by their types, such as optical characteristics, such as contrast, edge type, color variation, brightness, etc. For example, the AI/ML program software may classify preferred objects, with respect to an image type, according to, for example, the calculated registration error, for a large number of such combinations.

For this matter, a plurality of remote viewing stations 12 may communicate the source images, the selected portion indicators, the respective image portions, the respective panorama registration and/or creation processes, and the resulting registration errors to central computing facility such as an imaging server 16. An AWL program software operating in the central computing facility (e.g., imaging server 16) may then analyze the various panorama creation strategies to develop an optimal algorithm for creating (registering) a panorama image in any particular situation such as a combination of an image type and shared object type as described above.

The central computing facility (e.g., imaging server 16) may then communicate the algorithm, or parameters of such algorithm, to one or more remote viewing station 12, as well as to one or more cameras 11.

Thereafter, a camera may use the algorithm to determine preferred high-resolution image portions and send them with their respective low-resolution images.

Alternatively, or additionally, the remote viewing station 12 may use the algorithm to determine the image type, determine preferred shared objects, determine preferred high-resolution image portions, determine respective portion identifiers, and send the portion identifiers to the camera 11.

Alternatively, or additionally, the remote viewing station 12 may use the algorithm to determine the image type, and the preferred shared object types, and send to the camera 11 a request for high-resolution image portions of the preferred shared object types.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A method for registering together two or more images at least partly overlapping the method comprising:
acquiring a plurality of at least partly overlapping high-resolution images by an imaging device in a first location;
converting, in said first location, said plurality of least partly overlapping high-resolution images into a respective plurality of least partly overlapping low-resolution images;
communicating said plurality of at least partly overlapping low-resolution images, via a communication network, to a panorama creation device in a second location;
identifying, in said second location, at least one shared object within an overlapping part of at least two images of said plurality of least partly overlapping low-resolution images;
communicating, from said first location to said second location, high-resolution image portions of said at least two images, said image portions including said shared object; and
registering said at least two images based on said shared object in said high-resolution image portions.

2. A method for creating a panorama image, said method comprising:
acquiring, by a panorama assembly station, via a communication network, from a camera in a remote location, a plurality of low-resolution images;
acquiring, by said panorama assembly station, via said communication network, from said camera a plurality of high-resolution image portions of said images; and
assembling, in said panorama assembly station, a panorama image comprising said low-resolution images by registering said low-resolution images using said high-resolution image portions.

3. The method according to claim 2, additionally comprising at least one of:
wherein each of said high-resolution image portion has area much smaller than its respective low-resolution image;
wherein each of said high-resolution image portions comprises a small part of its respective low-resolution image;
wherein said high-resolution image portion is selected by said panorama assembly station;
wherein said high-resolution image portion is selected by said panorama assembly station from a plurality of high-resolution image portions associated with said low-resolution image;
wherein said high-resolution image portions include objects shared by at least two of said low-resolution source image;
wherein said panorama assembly station determines said high-resolution image portions around objects shared by at least two of said low-resolution source image; and
wherein said high-resolution image portions includes at least one feature accurately associated with at least one feature of said low-resolution source image.

4. The method according to claim 2, additionally comprising at least one of:
recognizing, in said panorama assembly station, at least one common object in at least two low-resolution images;
defining, in said panorama assembly station, for each of said at least two low-resolution images, an image portion comprising said common object;
communicating, from said panorama assembly station to said camera, a request for a high-resolution image data of said image portions;
receiving, by said panorama assembly station from said camera, said high-resolution image portions; and
assembling, in said panorama assembly station, said at least two low-resolution images, according to said common object in said respective high-resolution image portions.

5. The method according to claim 4 wherein a low-resolution panorama image is assembled in real-time remotely from said first location of acquiring said plurality of source images by a camera, and wherein said panorama image comprises high-resolution registration of said source images.

6. The method according to claim 4, wherein said camera in said first location and said remote panorama assembly station are connected by a limited-bandwidth communication network, said limited-bandwidth being insufficient to communicate high-resolution images of said low-resolution images in real-time.

7. The method according to claim 2, additionally comprising:
identifying a plurality of characteristics of at least one of said images, said image portions, and objects shared by at least two of said low-resolution source images;
calculating registration error for said panorama image;
identifying a set of said shared objects for which said registration error is at least one of minimal and smaller than a threshold value; and determining characteristics of at least one of said images, said image portions, and shared objects resulting in said registration error being at least one of minimal and smaller than a threshold value.

8. A system for registering together two or more images at least partly overlapping the system comprising:
A first device comprising:
an image capturing module acquiring a plurality of at least partly overlapping high-resolution images;
a resolution conversion module converting said plurality of least partly overlapping high-resolution images into a respective plurality of least partly overlapping low-resolution images; and
a communication module configured to communicate:
said plurality of at least partly overlapping low-resolution images, via a communication network, to a second device; and
a plurality high-resolution image portions; and
said second device comprising:
a portion identification module providing a portion identifier for at least one image portion of at least one of said low-resolution images;
a communication module configured to:
receive said plurality of at least partly overlapping low-resolution images, from said first device, via said communication network;
send said portion identifier to said first device; and
receive a plurality high-resolution image portions, from said first device, via said communication network;
an image registering module registering at least two of said low-resolution images using said high-resolution image portions.
identifying at least one shared object within an overlapping part of at least two images of said plurality of least partly overlapping low-resolution images,

9. A device for creating a panorama image, said device comprising:
a communication module configured to receive image data from a remote image capturing device, said image data comprising:
a plurality of low-resolution images; and
a plurality of high-resolution image portions of said images;
a panorama creation module registering said low-resolution images using said high-resolution image portions.

10. The device according to claim 9, additionally comprising at least one of:
wherein each of said high-resolution image portion has area much smaller than its respective low-resolution image;
wherein each of said high-resolution image portions comprises a small part of its respective low-resolution image;
wherein said high-resolution image portion is selected by said panorama assembly station;
wherein said high-resolution image portion is selected by said panorama assembly station from a plurality of high-resolution image portions associated with said low-resolution image;
wherein said high-resolution image portions include objects shared by at least two of said low-resolution source image;
wherein said panorama assembly station determines said high-resolution image portions around objects shared by at least two of said low-resolution source image; and
wherein said high-resolution image portions includes at least one feature accurately associated with at least one feature of said low-resolution source image.

11. The device according to claim 9, additionally comprising at least one of:
an artifact module recognizing at least one common object in at least two low-resolution images; and
an image portion module configured to execute at least one of:
select an image portion comprising said common object for each of said at least two low-resolution images; and
define an image portion comprising said common object for each of said at least two low-resolution images.

12. The device according to claim 9, wherein said communication module additionally configured to communicate a request for a high-resolution image data of said image portions.

13. The device according to claim 11, wherein said panorama creation module registers said low-resolution images according to said common object in said respective high-resolution image portions

14. The device according to claim 9, wherein a low-resolution panorama image is assembled in real-time remotely from said remote image capturing device, and wherein said panorama image comprises high-resolution registration of said low-resolution images.

15. The device according to claim 9, wherein said device and said remote image capturing device are connected by a limited-bandwidth communication network, said limited-bandwidth being insufficient to communicate high-resolution images of said low-resolution images in real-time.

16. The device according to claim 9, additionally comprising:
a portion selection module comprising computing processes for:
identifying a plurality of characteristics of at least one of said images, said image portions, and objects shared by at least two of said low-resolution source images;
calculating registration error for said panorama image;
identifying a set of said shared objects for which said registration error is at least one of minimal and smaller than a threshold value; and determine characteristics of at least one of said images, said image portions, and shared objects resulting in said registration error being at least one of minimal and smaller than a threshold value.

17. A remote image capturing device comprising:
an image capturing module configured to acquire and store high-resolution images;
a resolution conversion module converting said plurality of least partly overlapping high-resolution images into a respective plurality of least partly overlapping low-resolution images; and
a communication module configured to:
send said plurality of at least partly overlapping low-resolution images, via a communication network, to a second device; and
receive a request for a high-resolution image portion;
send said high-resolution image portions.

18. The device according to claim 17, wherein said request for a high-resolution image portion comprises at least one characteristic of at least one of said images, said image portions, and shared objects;
wherein said at least one characteristic is determined by:
identifying a plurality of characteristics of at least one of said images, said image portions, and objects shared by at least two of said low-resolution source images;
calculating registration error for a panorama image constructed from a plurality of said images;
identifying a set of said shared objects for which said registration error is at least one of minimal and smaller than a threshold value; and
determine characteristics of at least one of said images, said image portions, and said shared objects resulting in said registration error being at least one of minimal and smaller than a threshold value.
